(19) United States
(12) Patent Application Publication
(10) Pub. No.: US 2014/0267440 A1
(43) Pub. Date: Sep. 18, 2014

(54) DISPLAY CONTROL APPARATUS, DISPLAY CONTROL SYSTEM, DISPLAY CONTROL METHOD, AND COMPUTER PROGRAM PRODUCT

(71) Applicant: Tomoyuki Tsukuda, Kanagawa (JP)

(72) Inventor: Tomoyuki Tsukuda, Kanagawa (JP)

(21) Appl. No.: 14/351,962

(22) PCT Filed: Oct. 26, 2012
(86) PCT No.: PCT/JP2012/078413

§ 371 Date: Apr. 15, 2014

(30) Foreign Application Priority Data
Nov. 30, 2011 (JP) 2011-262970
Jul. 5, 2012 (JP) 2012-151474

(51) Int. Cl. G06T 11/60; G06T 3/20

(52) U.S. Cl. CPC G06T 11/60; G06T 3/20
USPC 345/681; 345/619

(57) ABSTRACT

A display control apparatus includes a storage unit that stores a stored output image that is already displayed by a display unit and a drawn image that is drawn on the display unit by a user when the stored output image is displayed by the display unit, a determination unit that determines whether the output image output by the information processing apparatus corresponds to the stored output image stored in the storage unit, a storage control unit that prompts the storage unit to store the output image output by the information processing apparatus when the determination unit determines that the output image output by the information processing apparatus does not correspond to the stored output image stored in the storage unit, and a display control unit that prompts the display unit to display the output image that is output by the information processing apparatus and stored in the storage unit.

### TECHNICAL FIELD

The present invention relates to a display control apparatus, a display control system, a display control method, and a computer program product including a computer program for executing the display control method.

### BACKGROUND ART

Various types of display apparatuses for use at a meeting are known in the prior art (see e.g., Japanese Laid-Open Patent Publication No. 2011-141835). The conventional display apparatus may be connected to a personal computer (PC) that outputs an output image to the display apparatus so that the display apparatus may display the output image. Further, a technique is known for enabling a user to draw characters and/or images on a display region of the display apparatus. In this way, the display apparatus may display the drawn image superposed on the output image output by the PC.

FIGS. 1A-1C are diagrams illustrating problems of the related art. FIG. 1A shows an exemplary output image that is output from a PC 2 to a display apparatus 1. In FIG. 1A, a pie chart image is output from the PC 2 as the output image. FIG. 1B shows an exemplary drawn image that is added onto the output image. In FIG. 1B, a user adds the word “IMPORTANT” as the drawn image onto the output image. FIG. 1C shows a case in which the output image from the PC 2 is switched to another output image. In FIG. 1C, an output image with the heading “TODAY′S SUMMARY” is displayed. In the conventional display apparatus, the drawn image “IMPORTANT” displayed with the previous output image remains displayed in the display region even after another output image is displayed so that the output image displayed after a drawn image is displayed could not be displayed as desired.

### DISCLOSURE OF THE INVENTION

### Problems to be Solved by the Invention

It is a general object of at least one embodiment of the present invention to provide a display control apparatus, a display control system, a display control method, and a computer program that can substantially obviate one or more problems caused by the limitations and disadvantages of the related art.

One particular object of at least one embodiment of the present invention is to provide a display control apparatus, a display control system, a display control method, and a computer program that can accurately display an output image output by an information processing apparatus even when the output image is switched or altered.

### Means for Solving the Problems

According to one embodiment of the present invention, a display control apparatus that prompts a display unit to display an output image output by an information processing apparatus includes a storage unit that stores a stored output image that is already displayed by the display unit in association with a drawn image that is drawn on the display unit by a user when the stored output image is displayed by the display unit; a determination unit that determines whether the output image output by the information processing apparatus corresponds to the stored output image stored in the storage unit; a storage control unit that prompts the storage unit to store the output image output by the information processing apparatus when the determination unit determines that the output image output by the information processing apparatus does not correspond to the stored output image stored in the storage unit; and a display control unit that prompts the display unit to display the output image that is output by the information processing apparatus and stored in the storage unit.

### Effects of the Present Invention

According to an aspect of the present invention, an output image output by an information processing apparatus may be accurately displayed on a display unit even when the output image is switched or altered.

### BRIEF DESCRIPTION OF THE DRAWINGS

FIGS. 1A-1C are diagrams illustrating problems of the related art;

FIG. 2 is a block diagram showing an exemplary configuration of a display system according to an embodiment of the present invention;

FIG. 3 is a perspective view of a display control apparatus according an embodiment of the present invention;

FIG. 4 is a block diagram showing an exemplary hardware configuration of the display control apparatus;

FIG. 5 is a block diagram showing another exemplary hardware configuration of the display control apparatus;

FIG. 6 is a block diagram showing an exemplary functional configuration of a control unit of the display control apparatus;

FIG. 7 is a flowchart showing exemplary process steps performed by the display control apparatus;

FIG. 8 is a diagram showing an exemplary display image list stored in a storage unit of the display control apparatus;

FIGS. 9A-9C are diagrams showing examples of output images and display images;

FIG. 10 is a diagram showing another exemplary display image list;

FIG. 11 is a diagram showing another exemplary display image list;

FIG. 12 is a diagram showing another exemplary display image list;

FIGS. 13A-13C are diagrams showing other examples of output images and display images;

FIG. 14 is a block diagram showing another exemplary functional configuration of the control unit according to another embodiment;

FIG. 15 is a diagram showing another exemplary display image list;

FIG. 16 is a table showing an exemplary manner in which a display image list is stored in association with a user ID;

FIG. 17 is a diagram showing exemplary determination blocks used in a determination process according to an embodiment of the present invention;

FIG. 18 is a diagram showing another exemplary display image list;

FIG. 19 is a diagram showing exemplary test regions used in a calculation process according to an embodiment of the present invention;

FIG. 20 is a diagram showing an exemplary image layer configuration of a display image; and

FIGS. 21A-21B are diagrams showing other examples of output images and display images.

### DESCRIPTION OF THE REFERENCE NUMERALS

100: INFORMATION PROCESSING APPARATUS
200: DISPLAY CONTROL APPARATUS
202: DISPLAY UNIT
202a: DISPLAY REGION
204: MOUNTING TABLE
206: PRINTER ACCOMMODATING UNIT
208: VIDEO ACCOMMODATING UNIT
210: COMPUTER ACCOMMODATING UNIT
250: CONTROL UNIT
252: MAIN STORAGE UNIT (STORAGE UNIT)
254: AUXILIARY STORAGE UNIT
256: EXTERNAL STORAGE DEVICE INTERFACE
259: EXTERNAL APPARATUS CONNECTION INTERFACE
260: NETWORK INTERFACE
262: OPERATIONS UNIT
300: DETERMINATION UNIT
302: DISPLAY CONTROL UNIT
304: STORAGE CONTROL UNIT
306: DETECTION UNIT
308: CALCULATION UNIT

### MODE FOR CARRYING OUT THE INVENTION

In the following, embodiments of the present invention are described with reference to the accompanying drawings. It is noted that identical features and components used in different embodiments are given the same reference numerals and their descriptions are omitted.

### First Embodiment

FIG. 2 shows an exemplary functional configuration of a display system 1000 according to a first embodiment of the present invention. The display system 1000 includes an information processing apparatus 100 and a display control apparatus 200. The information processing apparatus 100 may be a PC, a tablet, or a smart phone, for example. When a user inputs an output command to the information processing apparatus 100, an image (referred to as “output image” hereinafter) is output from the information processing apparatus 100 to the display control apparatus 200. The output image may be text, graphics, patterns, or a combination thereof, for example. It is noted that the display control apparatus 200 continues to display the output image while the information processing apparatus 100 outputs the output image.

The display control apparatus 200 and the display system 1000 are preferably adapted for use in a meeting. Accordingly, in the following descriptions, it is assumed that the display control apparatus 200 and the display system 1000 are used in a meeting.

FIG. 3 is a perspective view of the display control apparatus 200 from the front side. The display control apparatus 200 shown in FIG. 3 includes a display unit 202, a mounting table 204, a printer accommodating unit 206, a video accommodating unit 208, a computer accommodating unit 210, and casters 212. The display unit 202 includes a display region 202a on which the output image from the information processing apparatus 100 is displayed.

The display unit 202 may include a projector or a flat panel made of liquid crystal or plasma with a screen size of about 40-60 inches, for example. The display unit 202 also has a touch panel function. A user (e.g., presenter of a meeting) may use drawing means to draw an image on the display unit 202. In a case where an output image is displayed by the display unit 202, the user may superpose the image drawn on the display unit 202 onto the output image displayed by the display unit 202 to present various items of information. It is noted that the drawing means may be the user's fingertips, a stylus pen, or an operations unit 262 (e.g., a mouse or keyboard) shown in FIG. 4, for example. It is noted that the image drawn by the user using the drawing means is referred to as “drawn image” hereinafter.

The operations unit 262 (e.g., mouse or keyboard) is mounted on the mounting table 204 so that the operations unit 262 may be used to input information to the display control apparatus 200. The front side of the printer accommodating unit 206 is arranged into a door and the door may be opened to accommodate a printer (not shown) for printing the output image displayed by the display unit 202.

The front side of the video accommodating unit 208 is arranged into a door and the door may be opened to enable the user to load or eject an external medium such as a video tape or a laser disk. The front side of the computer accommodating unit 210 is arranged into a door and the door may be opened to accommodate a computer (corresponding to a control unit 250, a main storage unit 252, and an auxiliary storage unit 254 shown in FIG. 4). The casters 212 are arranged at the bottom of the display control apparatus 200 so that the display control apparatus 200 may be moved to a desired location.

FIG. 4 is a block diagram showing an exemplary hardware configuration of the display control apparatus 200. In FIG. 4, the display control apparatus 200 includes the control unit 250, the main storage unit (also referred to as “storage unit”) 252, the auxiliary storage unit 254, an external storage device interface 256, an external apparatus connection interface 259, a network interface 260, the operations unit 262, and the display unit 202.

The control unit 250 controls the operations of various units and performs data computation and processing within the computer (i.e., the computer accommodated inside the computer accommodating unit 210 shown in FIG. 3). The control unit 250 executes programs stored in the main storage unit 252, receives data from the outside, computes and processes the received data, and outputs the resulting processed data.

The main storage unit 252 may be a ROM (Read-Only Memory) and a RAM (Random Access Memory), for example, that stores data and programs of basic software such as operating software and application software to be executed by the control unit 250.

The auxiliary storage unit 254 may be a HDD (Hard Disk Drive) that stores data associated with application software, for example. The external storage device interface 256 is as an interface between the display control apparatus 200 and a storage medium 258 (e.g., USB memory or CD-ROM) that is connected to the display control apparatus 200 via a data transmission line such as a USB (Universal Serial Bus).

The storage medium 258 stores a predetermined program that may be installed in the display control apparatus 200 via the external storage device interface 256 to be executed by the display control apparatus 200.

The external apparatus connection interface 259 may be a physical interface such as a VGA (Video Graphics Array) input connector or a USB port for establishing connection between the display control apparatus 200 and an external apparatus such as the information processing apparatus 100 (e.g., PC) shown in FIG. 2.

The network interface 260 acts as an interface between the display control apparatus 200 and the information processing apparatus 100 that is connected to the display control apparatus 200 via a network such as a local area network (LAN) or a wide area network (WAN) made up of wired and/or wireless data transmission lines.

The operations unit 262 may be a mouse or a keyboard, for example, that enables a user to input various commands to the display control apparatus 200. For example, the operations unit 262 may be operated by the user to start or end an application installed in the display control apparatus 200.

FIG. 5 is a block diagram showing another exemplary hardware configuration of the display control apparatus 200. In FIG. 5, the display control apparatus 200 includes the control unit 250, the main storage unit 252, the auxiliary storage unit 254, the external storage device interface 256, the external apparatus connection interface 259, the network interface 260, the operations unit 262, and a touch panel driver 264.

It is noted that in FIG. 5, the display unit 202 corresponds to an external apparatus that is connected to the display control unit 200 via the external apparatus connection interface 259. Also, in FIG. 5, a touch panel 266 is connected to the display control apparatus 200 via the touch panel driver 264.

The touch panel 266 realizes the touch panel function of the display unit 202. The touch panel 266 includes a receiving unit 268 that receives a wireless signal from a drawing unit 270. The drawing unit 270 may be an electronic pen, for example, that may be operated on the touch panel 266 to generate a drawn image or to select an image being displayed. For example, the receiving unit 268 may receive a signal from the drawing unit 270 indicating that the touch panel 266 has been touched.

The touch panel 266 is arranged to overlap with the display unit 202. When an image is drawn by operating the drawing unit 270 on the touch panel 266, the drawn image is displayed together with the output image displayed by the display unit 202.

It is noted that in the example shown in FIG. 5, the drawing unit 270 and the receiving unit 268 are arranged to establish wireless communication. However, in other examples, the drawing unit 270 and the receiving unit 268 may establish communication using a cable. Also, in FIG. 5, the drawing unit 270 is used to draw an image on the touch panel 266. However, in other examples, the touch panel 266 may be configured to generate a drawn image by other means such as through detecting a touch of the user's fingertips.

The display unit 202 of FIG. 5 may be a flat panel made of liquid crystal or plasma or a projection device such as a projector, for example.

FIG. 6 is a block diagram showing an exemplary functional configuration of the control unit 250. In the example shown in FIG. 6, the control unit 250 includes a determination unit 300, a display control unit 302, a storage control unit 304, and a detection unit 306.

FIG. 7 is a flowchart showing exemplary process steps performed by the display control apparatus 200. In one preferred embodiment, the process of FIG. 7 may be periodically performed at intervals of a predetermined time period t (e.g., 10 ms).

To start the display control process of FIG. 7, first, the user prompts the display control apparatus 200 to recognize that a meeting has started.

For example, the display control apparatus 200 may be arranged to recognize the start of a meeting when an application downloaded in the display control apparatus 200 for executing a display control function according to an embodiment of the present invention is started. In another example, the display control apparatus 200 may be arranged to recognize the start of a meeting when the main switch of the display control apparatus 200 is turned on.

<First-Time Process>

In the following, exemplary process steps of a first-time process performed for the first time right after the start of a meeting (i.e., process performed after the predetermined time period t has elapsed from the time the display control apparatus 200 recognizes the start of the meeting) are described.

When the display control apparatus 200 recognizes the start of a meeting, the determination unit 300 determines whether an output image is stored in the storage unit 252 (S71).

In the present embodiment, the storage unit 252 is configured to store one or more output images output from the information processing apparatus 100 via the external apparatus connection interface 259 or the network interface 260. In the following, the output image stored in the storage unit 252 is referred to as “stored output image” and the image output by the information processing apparatus 100 is referred to as “output image.”

When the display control process of FIG. 7 is performed for the first time, the storage unit 252 does not have any stored output images. Accordingly, in step S71, the determination unit 300 determines that no stored output images are stored in the storage unit 252 (NO in S71), and the process proceeds to step S73.

In step S73, the storage control unit 304 captures a new output image output by the information processing apparatus 100 and stores the captured output image in the storage unit 252 as a stored output image.

FIG. 8 shows an exemplary manner in which the stored output image is stored in the storage unit 252 in the present example. In FIG. 8, the storage unit 252 stores the stored output image in a display image list. It is noted that “display image” refers to an image displayed by the display unit 202 that may include the output image output by the information processing apparatus 100 and a drawn image that is drawn on the output image.

In the present example, an image has not yet been drawn by the user so that no drawn image is stored in the display image list and only a stored output image X is stored as “display image 1”. The display image list of FIG. 8 indicates a reference address (storage address) of the stored output image X within the storage unit 252 and the display size of the output image X. The display size is determined by the number of pixels in the vertical direction (height) and the number of pixels in the lateral direction (width).

In step S74, the display control unit 302 generates a composite image using the stored output image X (see FIG. 8) corresponding to the output image output by the information processing apparatus 100. That is, a drawn image to be combined with the stored output image X is not stored in the display image list in the present example so that the stored output image X alone is used to generate the composite image. Then, in step S75, the display control unit 302 prompts the display unit 202 to display the composite image corresponding to the stored output image X after which the process is ended. It is noted that in step S74, the display control unit 302 may alternatively generate the composite image by combining the stored output image X and a NULL image as the drawn image, for example.

FIGS. 9A-9C show exemplary output images output by the information processing apparatus 100 and exemplary display images displayed on the display region 202a of the display unit 202. FIG. 9A shows a case in which the information processing apparatus 100 outputs the output image X (i.e., a pie chart image in this example), and the display control apparatus 200 performs steps S71, S73, S74, and S75 to display the output image X on the display region 202a.

As is described above, in one preferred embodiment, the display control process of FIG. 7 may be periodically performed at intervals of the predetermined time period t. In this case, the display control process of FIG. 7 may be restarted from step S71 after the elapse of the predetermined time period t (e.g., 10 ms).

<Subsequent Process>

In the following, exemplary process steps of a subsequent process performed after the first-time process (i.e., process performed after the predetermined time period t elapses from the time the first-time process is completed) are described. In the example described below, it is assumed that the information processing apparatus 100 is outputting the output image X to the display control apparatus 200 as is shown in FIG. 9A.

In step S71, the determination unit 300 determines whether a stored output image is stored in the storage unit 252. Since the storage unit 252 stores the stored output image X in the present example, the determination unit 300 determines that a stored output image is stored (YES in S71).

In step S72, the determination unit 300 determines whether the output image corresponds to the stored output image, and whether the output image position corresponds to the stored output image position. It is noted that the determination as to whether the output image corresponds to the stored output image may be referred to as “first determination” and the determination as to whether the output image position corresponds to the stored output image position may be referred to as “second determination.” Also, it is noted that “output image position” refers to the position of the output image within the display region 202a of the display unit 202.

It is noted that in the second determination, the determination unit 300 may determine that the output image position does not correspond to the stored output image position when the output image output by the information processing apparatus 100 is scrolled, for example. The scrolling of the output image may be performed at the information processing apparatus 100 (e.g., by drag-and-drop operations or window scrolling operations using a mouse) or at the display unit 202. For example, the user may perform scrolling operations on the display unit 202 using the touch panel function of the display unit 202 (e.g., sliding a finger against the display unit 202).

In the present example where the output image X (pie chart image) is output by the information processing apparatus 100 and the same output image is displayed on the display region 202a as is shown in FIG. 9A, the output image X (pie chart image) is stored in the storage unit 252 in step S73 as is shown in FIG. 8. Further, since the output image X (pie chart image) output by the information processing apparatus 100 has not been changed and the user has not scrolled the output image X, in step S72, the determination unit 300 determines that the output image corresponds to the stored output image and determines that the output image position corresponds to the stored output image position. Thus, the process proceeds to step S76.

In step S76, if a drawn image is drawn by a user, the storage control unit 304 stores the drawn image in the storage unit 252 in association with the stored output image that has been determined t correspond to the output image output by the information processing apparatus 100. It is noted that the drawn image corresponds to an image drawn on the display unit 202 by the user (presenter) using drawing means (e.g., finger tips or a stylus pen) as is described above.

It is noted that in the present embodiment, the detection unit 306 determines whether an image has been drawn by the user. The detection unit 306 detects when the drawing means has come into contact with the display unit 202 and determines that an image has been drawn by the drawing means. In the exemplary case shown in FIG. 9A, since no image is drawn on the display unit 202 by the user, step S76 is skipped and the process proceeds to step S77. On the other hand, in a case where an image has been drawn on the display unit 202, the detection unit 306 determines the coordinates of the drawn image.

In step S77, the display control unit 302 combines the stored output image determined to correspond to the output image (the output image X shown in FIG. 8 in the present example) and the drawn image stored in association with the stored output image to generate a composite image (if applicable). Since a drawn image is not stored in association with the stored output image in the present example, only the stored output image X is used to generate the composite image.

Then, in step S75, the display control unit 302 prompts the display unit 202 to display the composite image (corresponding to the stored output image X in the present example). It is noted that at the time step S75 is completed, the output image output by the information processing apparatus 100 and the display image displayed by the display unit 202 may remain as is shown in FIG. 9A.

<Process for Displaying Drawn Image>

In the following, exemplary process steps of the display control process of FIG. 7 when a user draws an image on the display unit 202 are described. In the example described below, it is assumed that a drawn image x is drawn by the user on the output image X displayed by the display unit 202 as is shown in FIG. 9B. The drawn image x shown in FIG. 9B includes the word “IMPORTANT” and a wavy line surrounding the word. In the case where the drawn image x is drawn by the user, the display control apparatus 200 may perform the display control process of FIG. 7 in the manner described below.

In step S71, since the stored output image X is stored in the storage unit 252 in the present example, the determination unit 300 makes a positive determination (YES). Then, the determination unit 300 determines that the output image X (i.e., pie chart image) corresponds to the stored output image X in the first determination of step S72, and determines that the output image position corresponds to the stored output image position in the second determination of step S72. Thus, the process proceeds to step S76.

In step S76, if a drawn image is detected, the storage control unit 304 stores the drawn image in association with the stored output image that has been determined to correspond to the output image. Since the drawn image x is drawn by the user in FIG. 9B, the storage control unit 304 stores the drawn image x in association with the stored output image X that has been determined to correspond to the output image X output by the information processing apparatus 100.

FIG. 10 shows an exemplary display image list in which drawn images x₁ and x₂ are stored in association with the stored output image X shown in FIG. 8. In the example of FIG. 10, a drawn image xₙ (where n represents a natural number) corresponds to a one-stroke image. A one-stroke image refers to an image that is drawn during the time period from the time the drawing means (e.g., user's fingertips or a stylus pen) comes into contact with the display unit 202 until the time the drawing means ceases to be in contact with the display unit 202.

In FIG. 10, image characteristic values and an ID are stored for the drawn image xₙ. In the present example, image characteristic values correspond to RGB values, a line width, and coordinates of the drawn image xₙ. The coordinates correspond to the lateral and vertical pixel positions of the starting point of the drawn image xₙ within the display region 202a. It is noted that in FIG. 10, the stored drawn image corresponds to a one-stroke image. However, in a case where the display control process of FIG. 7 is performed at intervals of a predetermined time period t (e.g., 10 ms), an image drawn during the predetermined time period may be stored as the stored drawn image, for example.

In FIG. 9B, the drawn image x including the word “IMPORTANT” and the wavy line is made up of multiple one-stroke images. Accordingly, multiple drawn images x₁-xₙ may be stored in association with the stored output image X.

In step S77, the display control unit 302 combines the stored output image X that has been determined to correspond to the output image X with the drawn images x₁-xₙ stored in association with the stored output image X to generate a composite image. Then, in step S75, the display control unit 302 prompts the display unit 202 to display the composite image. In this way, the display unit 202 may display a composite image of the output image X and the drawn image x as is shown in FIG. 9B.

<Process when Output Image is Switched>

In the following, process steps of the display control process of FIG. 7 that are performed when the user (presenter of a meeting) switches (changes) the output image output by the information processing apparatus 100 are described. In the example described below, it is assumed that the user switches the output image from the output image X (corresponding to the pie chart image) to an output image Y (corresponding to a document image titled “TODAY′S SUMMARY”) as is shown in FIG. 9C.

In this case, since the stored output image X is already stored in the storage unit 252, the determination unit 300 makes a positive determination (YES) in step S71. In the first determination of step S72, the determination unit 300 determines whether the output image corresponds to the stored output image. In the present example, since the output image Y is not yet stored in the storage unit 252, the determination unit 300 determines that the output image does not correspond to the stored output image. Thus, the process proceeds to step S73.

In step S73, the storage control unit 304 stores the new output image Y that is output by the information processing apparatus 100 in the storage unit 252. FIG. 11 shows an exemplary display image list in which the new output image Y is stored. In FIG. 11, the output image Y is stored as “display image 2”. In step S74, the display control unit 302 generates a composite image using the stored output image Y corresponding to the output image Y output by the information processing apparatus 100 (i.e., the stored output image Y that is newly stored in step S73). Then, in step S75, the display control unit 302 prompts the display unit 202 to display the composite image corresponding to the stored output image Y.

In this way, the storage unit 252 may store one or more output images and/or drawn images that have already been displayed during a meeting. Also, the storage unit 252 may store one or more drawn images in association with a stored output image.

In the following, process steps of the display control process of FIG. 7 performed in a case where the user restores (switches back) the output image output by the information processing apparatus 100 to a previous state is described. For example, in the case of restoring the output image output by the information processing apparatus 100 from the state shown in FIG. 9C to FIG. 9B (switching back to output image X from output image Y), the determination unit 300 makes a positive determination (YES) in step S71, and determines that the output image corresponds to the stored output image and the output image position corresponds to the stored output image position in step S72. Since no images are drawn in the present example, step S76 is skipped and the process proceeds to step S77.

In step S77, the display control unit 302 combines the stored output image X determined to correspond to the output image output by the information processing apparatus 100 (stored output image X shown in FIG. 11) with the drawn image x stored in association with the stored output image X (drawn images x₁ and x₂ in FIG. 11) to generate a composite image, and in step S75, the display control unit 302 prompts the display unit 202 to display the composite image. That is, as in the present example, when the output image is switched back to an output image that has previously been output and displayed, the display unit 202 may display the previously displayed output image together with the drawn image that is stored in association with the previously displayed output image.

Also, in a case where the user draws a drawn image y (not shown) on the display unit 202 while the display image Y corresponding to the output image Y is displayed as is shown in FIG. 9C, the storage control unit 304 stores the newly drawn image as drawn image y1 in association with the stored output image Y in step S76. FIG. 12 shows an exemplary display image list in which the drawn image y1 is stored in association with the stored output image Y as “display image 2.” Then, in steps S77 and S75, the display control unit 302 combines the stored output image Y and the drawn image y1 to generate a composite image and displays the composite image on the display unit 202.

It is noted that in a case where the user switches an output image output by the information processing apparatus 100 without drawing any images on the display unit 202 while the output image output before the switch is displayed on the display unit 202, the storage unit 252 does not store any drawn images in association with the stored output image corresponding to the output image output before the switch.

According to one aspect of the present embodiment, the determination unit 300 determines whether an output image output by the information processing apparatus 100 corresponds to a stored output image stored in the storage unit 252. For example, in the case where the user draws an image x on the output image X as is shown in FIG. 9B and the user then switches the output image output by the information processing apparatus 100 from the output image X to the output image Y as is shown in FIG. 9C, the determination unit 300 determines that the output image output by the information processing apparatus 100 does not correspond to the stored output image stored in the storage unit 252. In turn, steps S73, S74, and S75 are performed so that a display image corresponding to the output image Y may be displayed.

In this way, when the output image X is switched to the output image Y, a display image corresponding to the output image Y may be accurately displayed without the drawn image x drawn on the output image X remaining displayed on the display unit 202.

According to another aspect of the present embodiment, in the case where the output image X and the drawn image x are displayed as is shown in FIG. 9B after which the output image Y is displayed as is shown in FIG. 9C and the user then has the information processing apparatus 100 output the output image X, for example, steps S71, S72, S76, and S77 are performed so that the output image X may be displayed together with the drawn image x that was drawn when the output image X was previously displayed on the display unit 202. In this way, the presenter and participants of a meeting may view the previously displayed output image as well as the drawn image that was previously drawn on the displayed output image.

### Second Embodiment

In the following, a second embodiment of the present invention for accommodating a case in which an output image is scrolled is described. In the example described below, it is assumed that a display image including the output image X and the drawn image x is displayed on the display region 202a of the display unit 202 as is shown in FIG. 13A (same as FIG. 9B). It is noted that in some cases, the user may wish to scroll the output image X as is shown in FIGS. 13B-13C depending on how the meeting proceeds. The scrolling may be performed at the information processing apparatus 100 side or at the display unit 202 side by performing a drag-and-drop operation, for example. It is noted that the output image X that has been scrolled is identified as “output image X′” hereinafter.

In FIG. 13B, the drawn image x does not follow the scrolling movement of the output image X. That is, the scrolled output image X′ and the drawn image x are not accurately positioned with respect to each other. According to the present embodiment, the drawn image x is moved according to the scrolling movement of the output image X so that the drawn image x may be accurately positioned with respect to the scrolled output image X′ as is shown in FIG. 13C.

FIG. 14 is a block diagram showing an exemplary functional configuration of the control unit 250 according to the second embodiment. It is noted that the control unit 250 according to the second embodiment differs from the first embodiment in that it includes a calculation unit 308 in addition to the functional units shown in FIG. 6.

In the following, process steps that are performed right after the output image X is scrolled to display the scrolled output image X′ (i.e., after the output image and display image change from FIG. 13A to FIG. 13B or FIG. 13C) are described with reference to FIG. 7. In the examples described below, it is assumed that the storage unit 252 stores a display image list as is shown in FIG. 10 before the output image is scrolled.

According to a first example, in step S71, the determination unit 300 makes a positive determination (YES). Then, in step S72, the determination unit 300 determines that the output image X′ corresponds to the stored output image X, but the position of the output image X′ does not correspond to the position of the stored output image X. Thus, the process proceeds to step S78.

In step S78, the calculation unit 308 calculates the offset distance d between the position of the output image X′ and the position of the stored output image X. It is noted that the manner in which the calculation unit 308 calculates the offset distance d is described later. The offset distance d includes a distance component in the X-axis direction and a distance component in the Y-axis direction.

Then, in step S79, the storage control unit 304 updates the stored output image X stored in the storage unit 252 to stored output image X′. Also, the storage control unit 304 updates the stored drawn image x stored in the storage unit 252 to drawn image x′. It is noted that the updating of the stored drawn image x to the drawn image x′ may be realized by moving the drawn image x by the offset distance d.

In the present example, it is assumed that the offset distance d calculated by the calculation unit 308 is +10 in both the X-axis direction and the Y-axis direction.

FIG. 15 shows an exemplary display image list stored in the storage unit 252 after the above-described updating processes of step S79 are performed. As can be appreciated by comparing FIG. 15 with FIG. 10, the storage output image X is updated to storage output image X′, the drawn image x₁ is updated to drawn image x₁′, the drawn image x₂ is updated to drawn image x₂′. Further, the X-axis coordinates and Y-axis coordinates of the drawn images x₁′ and x₂′ are incremented by +10.

In step S80, the updated stored output image X and the updated drawn image x′ are combined to generate a composite image. Then, in step S75, the display control unit 302 prompts the display unit 202 to display the composite image.

By performing the above process steps S78, S79, and S80, the scrolled output image and the drawn image that is moved by the offset distance d may be displayed by the display unit 202. In this way, even when the user scrolls an output image (e.g., output image X scrolled to output image X′) the drawn image associated with the output image may be adjusted according to the scrolling movement of the output image (e.g., drawn image x updated to drawn image x′).

It is noted that in the above first example, when the output image is scrolled, the storage control unit 304 updates the stored output image X to stored output image X′ and updates the stored drawn image x to stored drawn image x′ in step S79. Then, the display control unit 302 uses the updated stored output image X′ and the updated drawn image x′ to generate a composite image.

In a second example, instead of having the storage control unit 302 perform step S79, the detection unit 306 may be arranged to detect when the output image is scrolled, and the calculation unit 308 may be arranged to calculated the offset distance d. Then, the display control unit 302 may be arranged to prompt the display unit 202 to display the scrolled output image and the associated drawn image that is moved by the offset distance d.

In this example, in order to enable the detection unit 306 to detect when the output image is scrolled, the information processing 100 has to have a mechanism for sending a scrolling signal to the display control apparatus 200 indicating that the output image has been scrolled.

It is noted that in the first example, the information processing apparatus 100 does not need such a mechanism for sending a scrolling signal to the display control apparatus 200, and the display of the drawn image may be adjusted according to the scrolling movement of the output image by simply having the determination unit 300 determine whether the output image corresponds to the stored output image.

On the other hand, in the second example, the drawn image may be adjusted according to the scrolling movement of the output image without requiring the storage control 302 unit to perform step S79.

According to an aspect of, the present embodiment, even when an output image is scrolled, a drawn image associated with the output image may be adjusted according to the scrolling movement of the output image.

### Third Embodiment

In the following, the display image list that is generated during a meeting is described as a third embodiment of the present invention. The display image list such as that shown in FIG. 8 may be generated and stored in the storage unit 252 during a meeting.

It is noted that the display list according to the present embodiment may be generated each time a meeting is held, for example. One meeting may be from the time the start of the meeting is recognized until the end of the meeting is recognized, for example. The start of a meeting may be recognized when an application downloaded in the display control apparatus 200 for executing a display control function according to an embodiment of the present invention is started or when the main switch of the display control apparatus 200 is turned on, for example. The end of a meeting may be recognized when the application is ended or when the main switch of the display control apparatus 200 is turned off, for example.

In one embodiment, a display image list may be generated each time a meeting is held, and the generated display image list may be deleted when the meeting ends. In this way, the storage load of the storage unit 252 may be reduced.

In another embodiment, rather than deleting the display image list generated in a meeting, the display image list may be stored as an archive in association with predetermined identification information. The predetermined identification information may be a user ID or the date of the meeting, for example. FIG. 16 shows an example in which a display image list is stored in association with a user ID. By storing a display image list in association with predetermined identification information such as a user ID or the date of the meeting, an output image displayed in a previous meeting as well as a drawn image that was drawn when the output image was displayed in that previous meeting may be viewed later.

Also, by storing a display image list in association with a user ID, the display image list may be protected from being accessed by other users so that security of the display image list may be ensured, for example.

### Fourth Embodiment

In the following, a determination timing of the determination unit 300 is described as a fourth embodiment of the present invention.

The determination unit 300 may be arranged to make the determinations of step S72 of FIG. 7 periodically at intervals of a predetermined time period t, or the determination unit 300 may be arranged to make the determinations of step S72 when an output image is switched (e.g., when the output image is switched from FIG. 9B to FIG. 9C).

In the latter case, to enable the display control apparatus 200 to recognize the switching of the output image, the information processing apparatus 100 has a mechanism for sending an image switch signal to the display control apparatus 200 when an output image is switched.

It is noted that when the determination unit 300 is arranged to make the determinations of step S72 periodically at intervals of a predetermined time period t, the information processing apparatus 100 does not need the mechanism for sending the image switch signal described above. On the other hand, when the determination unit 300 is arranged to make the determinations of step S72 when the output image is switched, the frequency of performing the determination process may be reduced.

[Determination Unit 300]

In the following, an exemplary manner in which the determination unit 300 performs a determination process is described. In the example described below, the determination unit 300 is arranged to make a determination using normalized cross-correlation.

FIG. 17 illustrates an exemplary determination process performed by the determination unit 300. In the example of FIG. 17, the determination unit 300 uses determination blocks to determine whether the output image corresponds to the stored output image (i.e., whether they are the same). A determination block is made up of M×N pixels (where M and N both represent natural numbers), and the determination blocks are used for the output image and the stored output image. The determination unit 300 determines whether image characteristic values (e.g., RGB values) of the pixels of the output image covered by the determination block and the pixels of the stored output image covered by the determination block correspond.

In FIG. 17, the determination blocks of the output image and the stored output image are both arranged at positions corresponding to the coordinates (0, 0), and the determination unit 300 determines whether the image characteristic values of the pixels covered by the determination blocks correspond. When a determination is made as to whether the image characteristic values correspond, the determination blocks of the output image and the stored output image are both moved N pixels in the X-axis direction and the determination unit 300 repeats the determination of whether the image characteristic values of the pixels covered by the determination blocks correspond in a similar manner.

By repeating the process steps of determining whether the image characteristic values of pixels covered by the determination blocks correspond and moving the determinations blocks, the determination process may be performed on the entire regions of the output image and the stored output image. When the determination process is completed for the entire regions of the output image and the stored output image, the number of determination block pairs that have been determined to correspond are counted. In the present example, the number of determination block pairs having the same image characteristic values represents the degree of correspondence between the output image and the stored output image.

Next, the determination unit 300 determines whether the degree of correspondence (number of determination block pairs that have the same image characteristic values) is equal to or above a predetermined threshold value. The threshold value may be set equal to the total number S of determination blocks that make up the output image or the stored output image, or the threshold value may be set equal to a number slightly less than the total number S (e.g., S−1). That is, assuming the output image and the stored output image are each made up of Nₐₗₗ×Mₐₗₗ pixels, S=(Nₐₗₗ×Mₐₗₗ)÷(N×M).

In the case where the threshold value is set equal to S, the output image and the stored output image are determined to correspond when the image characteristic values of all the pixels of the output image and all the pixels of the stored output image are exactly the same. In the case where the threshold value is set equal to S−1, the output image and the stored output image may be determined to correspond even if there are slight differences in their image characteristic values.

Slight differences between the output image and the stored output image may occur when a pointer of a mouse is included in the output image being captured, for example. In such a case, even if the position of the mouse pointer in the output image and the position of the mouse pointer in the stored output image are different, the output image and the stored image actually represent the same image. Thus, the output image and the stored output image may be determined to correspond if the threshold value is set equal to a value slightly less than S.

It is noted that the determination process of the determination unit 300 using the determination blocks is described above as one illustrative example, and the determination unit 300 may use other means to determine the correspondence between the output image and the stored output image.

Also, it is noted that although the determination process using the determination blocks is described above in connection with determining whether the output image and the stored output image correspond, the determination blocks may be used in a similar manner to determine whether the output image position and the stored output image position correspond, for example.

[Calculation Unit 308]

In the following, an exemplary manner in which the calculation unit 308 calculates the offset distance d is described.

As is shown in FIG. 18, every time a stored output image is newly stored or a stored output image is updated, the calculation unit 308 designates X and Y coordinates of a test region within the stored output image. For example, in FIG. 18, X=40-50 and Y=30-60 are designated as the X and Y coordinates of the test region within the stored output image X′. It is noted that an image region within a stored output image having relatively high image characteristic values (e.g., RGB value or image density) is preferably selected as the test region.

Then, as is shown in FIG. 19, the calculation unit 308 searches the entire image region of the output image to find a region having image characteristic values that correspond to the image characteristic values of the test region of the stored output image. The region of the output image having the same image characteristic values as the test region of the stored output image is identified as the test region of the output image, and the calculation unit 308 calculates the offset distance d between the test region of the stored output image and the test region of the output image. In this way, the offset distance d between the stored output image and the output image may be determined.

[Background Image]

It is noted that various applications may be downloaded into the display apparatus 200 including an application for displaying an operations image (menu image) of the display control apparatus 200, for example. An image displayed by such an application may be referred to as “background image” or “application image”.

FIG. 20 is a diagram showing an exemplary layer configuration of a display image that may be displayed in a case where the application for displaying the background image is executed. The display image 430 shown in FIG. 20 includes a background image layer 400, an output image layer 410, and a drawn image layer 420. The background image layer 400 is for displaying a background image. The output image layer 410 is for displaying an output image. The drawn image layer 420 is for displaying a drawn image.

In FIG. 20, the background image layer 400 is arranged to be the uppermost layer so that the background image (i.e., operations image) may be prevented from being hidden by the output image or the drawn image. In one embodiment, a composite image of the above three image layers may be arranged to be displayed on the display unit 202 as the display image 430.

In another embodiment, a display image may be switched from that shown in FIG. 21A displaying an output image X to FIG. 21B displaying a background image Z and the output image X, for example. In such a case, the user may scroll the output image X to adjust its display position as is shown in FIG. 21B. It is noted that in a case where the user performs such scrolling operations, if a drawn image is drawn on the output image X, the display position of the drawn image may be adjusted according to the scrolling movement of the output image X by performing the determination and calculation processes similar to those described above in connection with the second embodiment.

Further, the present invention is not limited to these embodiments, and numerous variations and modifications may be made without departing from the scope of the present invention.

The present application is based on and claims the benefit of the priority dates of Japanese Patent Application Nos. 2011-262970 and 2012-151474, filed on Nov. 30, 2011, and Jul. 5, 2012, respectively, the entire contents of which are hereby incorporated by reference.

1. A display control apparatus that prompts a display unit to display an output image that is output by an information processing apparatus, the display control apparatus comprising:
a storage unit that stores the output image and a drawn image that is drawn on the display unit in association with each other; and
a display control unit that prompts the display unit to display the output image stored in the storage unit; wherein
in a case where the output image output by the information processing apparatus does not correspond to the output image stored in the storage unit, the display control unit prompts the storage unit to store the output image output by the information processing apparatus and prompts the display unit to display the output image stored in the storage unit.

2. The display control apparatus as claimed in claim 1, further comprising:
a determination unit that determines whether the output image output by the information processing apparatus corresponds to the output image stored in the storage unit; and
a calculation unit that calculates an offset distance between a position of the output image output by the information processing apparatus and a position of the output image stored in the storage unit within a display region of the display unit; wherein
the determination unit determines whether the position of the output image output by the information processing apparatus corresponds to the position of the output image stored in the storage unit;
the calculation unit calculates the offset distance when the determination unit determines that the output image output by the information processing apparatus corresponds to the output image stored in the storage unit and determines that the position of the output image output by the information processing apparatus does not correspond to the position of the output image stored in the storage unit; and
the display control unit prompts the display unit to display the output image output by the information processing apparatus and the drawn image that is moved within the display region according to the offset distance calculated by the calculation unit.

3. The display control apparatus as claimed in claim 1, wherein
when the output image output by the information processing apparatus corresponds to the output image stored in the storage unit and the position of the output image output by the information processing apparatus does not correspond to the position of the output image stored in the storage unit, the display control unit updates the output image stored in the storage unit to the output image output by the information processing apparatus and updates the drawn image stored in the storage unit to the drawn image that is moved according to the offset distance; and
the display control unit prompts the display unit to display the updated output image and the updated drawn image stored in the storage unit.

4. The display control apparatus as claimed in claim 1, wherein
when the output image output by the information processing apparatus corresponds to the output image stored in the storage unit and the position of the output image output by the information processing apparatus corresponds to the position of the output image stored in the storage unit, the display control unit prompts the display unit to display the output image stored in the storage unit and the drawn image that is stored in association with the stored output image.

5. The display control apparatus as claimed in claim 1, wherein
the output image stored in the storage unit and the drawn image stored in association with the stored output image are associated with each other according to predetermined identification information.

6. The display control apparatus as claimed in claim 2, wherein
the determination unit performs a determination process periodically at intervals of a predetermined time period.

7. A display system comprising:
a display control unit that prompts a display region to display an output image output by an information processing apparatus; and
a storage unit that stores the displayed output image and a drawn image in association with each other; wherein
in a case where the output image output by the information processing apparatus does not correspond to the output image stored in the storage unit, the display control unit prompts the storage unit to store the output image output by the information processing apparatus and prompts the display region to display the output image stored in the storage unit.

8. A display control method comprising:
prompting a display region to display an output image output by an information processing apparatus and a drawn image;
prompting a storage unit to store the output image and the drawn image in association with each other; and
in a case where a determination is made that the output image output by the information processing apparatus does not correspond to the output image stored in the storage unit, prompting the storage unit to store the output image output by the information processing apparatus and prompting the display region to display the output image stored in the storage unit.

9. (canceled)
